(19) United States
(12) Patent Application Publication
(10) Pub. No.: US 2015/0315839 A1
(43) Pub. Date: Nov. 5, 2015

(54) OPENING-CLOSING CONTROL DEVICE OF SLIDE DOOR

(71) Applicants: TOYOTA SHATAI KABUSHIKI KAISHA, Aichi (JP); AISIN SEIKI KABUSHIKI KAISHA, Aichi (JP)

(72) Inventors: Takeshi SHIGEMOTO, Kariya-shi (JP); Katsumi ITO, Kariya-shi (JP); Takuma KITO, Kariya-shi (JP); Koichi HIROTA, Kariya-shi (JP); Norio FUKUI, Kariya-shi (JP)

(73) Assignee: AISIN SEIKI KABUSHIKI KAISHA, Kariya-shi, Aichi-ken (JP)

(21) Appl. No.: 14/646,259

(22) PCT Filed: May 26, 2014
(86) PCT No.: PCT/JP2014/063839

§ 371 Date: May 20, 2015

(30) Foreign Application Priority Data
Jun. 14, 2013 (JP) 2013-125631

(51) Int. Cl. E05F 15/659; B60Q 1/00; G06F 1/16; B60J 5/06; G06F 3/041

(52) U.S. Cl. CPC E05F 15/659; B60J 5/06; G06F 3/041; G06F 1/16; B60Q 1/0023

(57) ABSTRACT

An opening-closing control device of a slide door that is configured to slide along a body side surface of a vehicle in a vehicle front-back direction using a motor as a drive source in order to open and close an entrance of the vehicle may include a touch panel for performing an opening-closing operation of the slide door, which touch panel is attached to an outer surface of a member constituting an outer shell of the vehicle, wherein the touch panel has a plurality of manipulating portions, and light sources corresponding to the manipulating portions, and wherein the light sources corresponding to the manipulating portions that are operable in accordance with opening-closing conditions of the slide door are configured to be turned on, so that images of the operable manipulating portions are illuminated.

### TECHNICAL FIELD

The present invention relates to an opening-closing control device of a slide door that is configured to slide along a body side surface of a vehicle in a vehicle front-back direction using a motor as a drive source in order to open and close an entrance of the vehicle.

### BACKGROUND ART

An art related to an opening-closing control device of a slide door of a vehicle is disclosed in JP2009-79353A. As shown in FIG. 10, the opening-closing control device of the slide door described in JP2009-79353A has capacitance sensors 101-105 that are embedded in a grip handle 100 of the slide door. When the grip handle 100 is traced with a hand, the capacitance sensors 101-105 detect a tracing direction or other such factors, so that the slide door can be slid in the direction. Naturally, it is possible to perform a normal door opening-closing operation by grasping the grip handle 100.

### SUMMARY OF THE INVENTION

### Problems to be Solved by the Invention

However, in the opening-closing control device of the slide door, it is difficult to know that the capacitance sensors 101-105 are embedded in the grip handle 100. Therefore, an inexperienced user cannot sufficiently utilize the capacitance sensors 101-105. As a result, such a user often performs the door opening-closing operation by grasping the grip handle 100 as is conventionally done. This may reduce the rate of utilization of the opening-closing control device of the slide door using the capacitance sensors 101-105.

Therefore, there is a need to provide an improved opening-closing control device of a slide door.

### Means for Solving the Problems

In a first aspect of the present invention, an opening-closing control device of a slide door that is configured to slide along a body side surface of a vehicle in a vehicle front-back direction using a motor as a drive source in order to open and close an entrance of the vehicle may include a touch panel for performing an opening-closing operation of the slide door, which touch panel is attached to an outer surface of a member constituting an outer shell of the vehicle, wherein the touch panel has a plurality of manipulating portions, and light sources corresponding to the manipulating portions, and wherein the light sources corresponding to the manipulating portions that are operable in accordance with opening-closing conditions of the slide door are configured to be turned on, so that images of the operable manipulating portions are illuminated. Further, the member constituting the outer shell of the vehicle may include a side mirror or other such members as well as a body and a door.

According to the first aspect of the present invention, the light sources corresponding to the manipulating portions that are operable in accordance with the opening-closing conditions of the slide door can be turned on, so that the images of the operable manipulating portions are illuminated. For example, when the slide door is fully closed, an operation for moving the slide door in an opening direction is allowed. That is, the light sources corresponding to the manipulating portions for moving the slide door in the opening direction can be turned on, so that the images of the manipulating portions can be illuminated. To the contrary, when the slide door is fully opened, an operation for moving the slide door in a closing direction is allowed. That is, the light source corresponding to the manipulating portion for moving the slide door in the closing direction can be turned on, so that the image of the manipulating portion can be illuminated. Therefore, even if a user is inexperienced in use of the touch panel, the user can easily utilize the touch panel.

In a second aspect of the present invention, the manipulating portions corresponding to the light sources that are turned out are in inoperable conditions. Therefore, even if the manipulating portions corresponding to the light sources that are turned out are inadvertently manipulated by the user, the slide door can be prevented from moving against user's will.

In a third aspect of the present invention, the touch panel is attached to a front frame constituting a window frame of the slide door. That is, the touch panel can be positioned adjacent to a grip handle of the slide door. Therefore, the user can easily touch the touch panel during the opening-closing operation of the slide door.

In a fourth aspect of the present invention, when the slide door is held in a fully-closed position, the light sources corresponding to a fully-opening manipulating portion and a half-opening manipulating portion are turned on, so that images of the fully-opening manipulating portion and the half-opening manipulating portion are illuminated.

In a fifth aspect of the present invention, when the slide door is held in a fully-opened position, the light source corresponding to a fully-closing manipulating portion is turned on, so that an image of the fully-closing manipulating portion is illuminated.

In a sixth aspect of the present invention, when the slide door is sliding, the light source of a stopping manipulating portion of the slide door is turned on, so that an image of the stopping manipulating portion is illuminated. Therefore, the touch panel can be prevented from being inadvertently operated.

In a seventh aspect of the present invention, when the slide door is held in a fully-closed position and is in a fully closed and locked condition, the light sources corresponding to all of the manipulating portions are turned out, so that the manipulating portions are in inoperable conditions.

### BRIEF DESCRIPTION OF THE DRAWINGS

FIG. 1 is a partial side view of a vehicle having an opening-closing control device of a slide door according to Embodiment 1 of the present invention.

FIG. 2 is a signal block diagram of the opening-closing control device of the slide door.

FIG. 3 is a view of a touch panel of the opening-closing control device of the slide door.

FIG. 4 is a sectional view taken along line IV-IV of FIG. 3.

FIG. 5A is a view illustrating an example of an image displayed on the touch panel.

FIG. 5B is a view illustrating an example of an image displayed on the touch panel.

FIG. 5C is a view illustrating an example of an image displayed on the touch panel.

FIG. 5D is a view illustrating an example of an image displayed on the touch panel.

FIG. 6 is a diagram illustrating conditions of the slide door and examples of images displayed on the touch panel.

FIG. 7 is a flow chart illustrating movements of the slide door.

FIG. 8 is a flow chart illustrating the movements of the slide door.

FIG. 9 is a view of a modified form of the touch panel.

FIG. 10 is an explanatory view of a conventional opening-closing control device of a slide door.

### MODE FOR CARRYING OUT THE INVENTION

### Embodiment 1

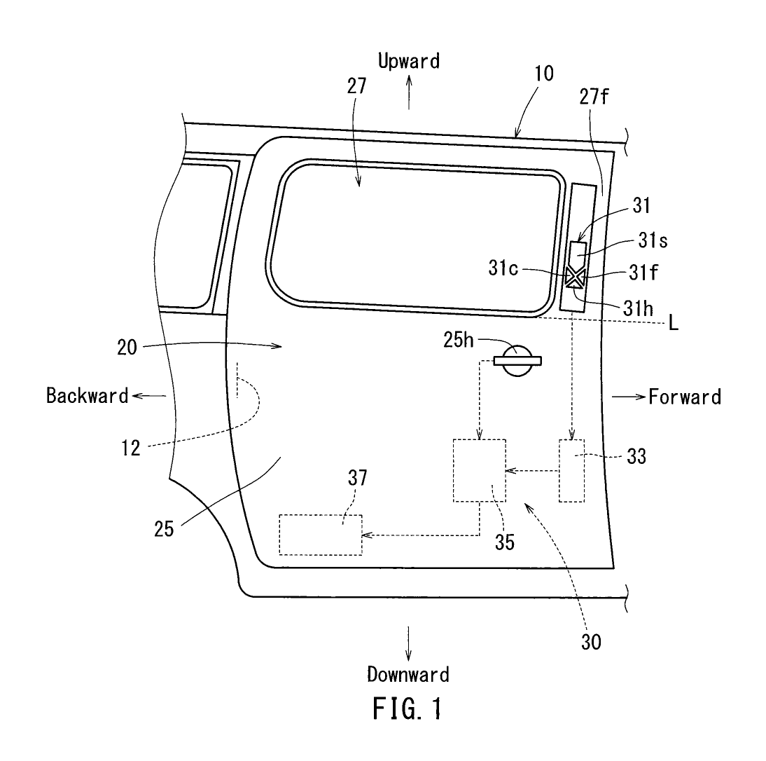

In the following, an opening-closing control device of a slide door according to Embodiment 1 of the present invention will be described with reference to FIGS. 1 to 9. The opening-closing control device of the slide door according to the present embodiment corresponds to an opening-closing control device of a right slide door of a van-type vehicle. Further, forward and backward, rightward and leftward, and upward and downward in the drawings respectively correspond to forward and backward, rightward and leftward, and upward and downward of the vehicle.

<Regarding Outline of Slide Door 20>

The van-type vehicle 10 (minivan) may have a driver side entrance and a passenger side entrance (not shown). Further, as shown in FIG. 1, the vehicle 10 may have a central entrances 12 that are respectively positioned behind the driver side entrance and the passenger side entrance. The driver side entrance and the passenger side entrance may respectively be configured to be opened and closed by hinged front doors (not shown). Conversely, the right and left central entrances 12 may respectively be configured to be opened and closed by right and left slide doors 20. Further, because the right and left slide doors 20 may have structures identical with each other, the right slide door 20 will be described as a representative thereof

As shown in FIG. 1 or other figures, the slide door 20 may be a power slide door (PSD) that is configured to slide along a body side surface of the vehicle 10 in a vehicle front-back direction using a motor 37 (a PSD motor 37) as a drive source in order to open and close the central entrance 12 of the vehicle. The slide door 20 may have a door main body 25, a window portion 27 and a grip handle 25h attached to the door main body 25. The grip handle 25h may be positioned adjacent to a belt line L in a front portion of the door main body 25. Further, the grip handle 25h may have an operation switch (not shown) for opening and closing the slide door 20. The operation switch of the grip handle 25h may be configured such that signals therefrom can be input to a PSD/ECU (a PSD electronic control unit) 35 which functions as a controller of the slide door 20. The PSD/ECU 35 may be constructed to actuate the motor 37 based on the signals from the operation switch of the grip handle 25h or signals from a touch panel ECU 33 (which will be hereinafter described) so as to slide the slide door 20 in a closing direction or an opening direction.

<Regarding Opening-Closing Control Device 30 of Slide Door 20>

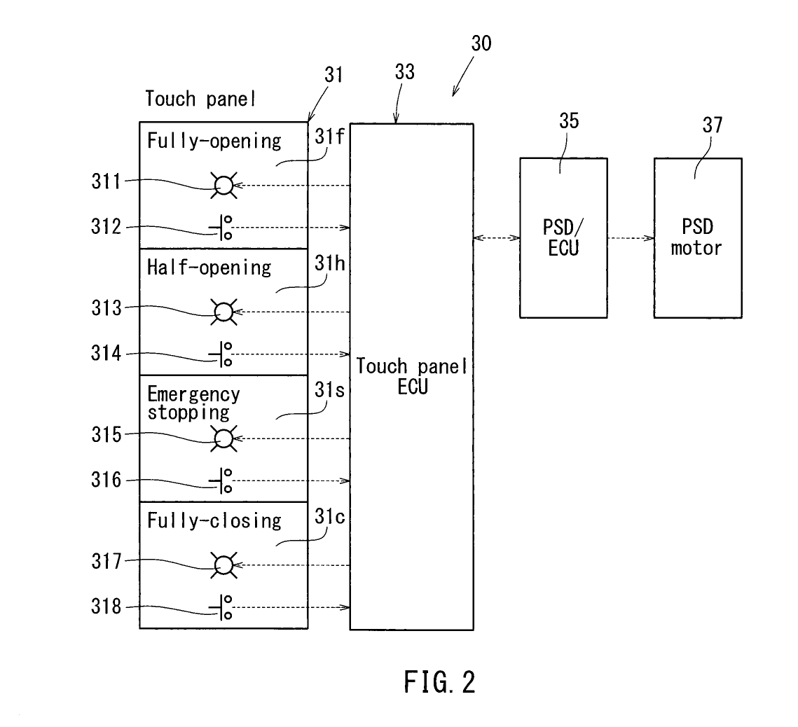

As shown in FIGS. 1 and 2, the opening-closing control device 30 of the slide door 20 may be a device for performing an opening-closing operation of the slide door 20 by manipulation of a touch panel 31 is manipulated. As shown in FIG. 2, the opening-closing control device 30 may be composed of a touch panel 31, the touch panel ECU 33, the PSD/ECU 35 and the PSD motor 37 (the motor 37).

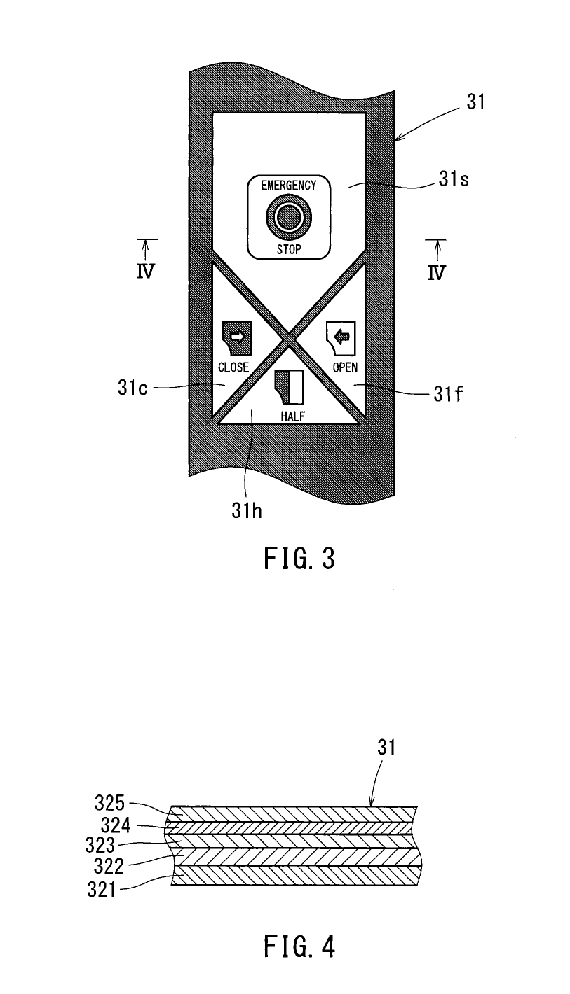

The touch panel 31 may be a panel that a user can touch the same with fingers for manipulation. As shown in FIG. 1, the touch panel 31 may be attached to an outer surface of a front frame 27f constituting an outer window frame of the slide door 20. As shown in FIGS. 2 and 3, the touch panel 31 may have a fully-opening manipulating portion 31f, a half-opening manipulating portion 31h, a stopping manipulating portion 31s and a fully-closing manipulating portion 31c.

The fully-opening manipulating portion 31f of the touch panel 31 may be a manipulating portion that is manipulated by touch when the user tries to fully open the slide door 20. As shown in FIG. 2, the fully-opening manipulating portion 31f may have a fully-opening LED 311 and a fully-opening switch 312 that is composed of a capacitance sensor. The half-opening manipulating portion 31h of the touch panel 31 may be a manipulating portion that is manipulated by touch when the user tries to half open the slide door 20. The half-opening manipulating portion 31h may have a half-opening LED 313 and a half-opening switch 314 that is composed of a capacitance sensor. The stopping manipulating portion 31s of the touch panel 31 may be a manipulating portion that is used for bringing the slide door 20 to an emergency stop when the slide door 20 is sliding. The stopping manipulating portion 31s may have a stopping LED 315 and a stopping switch 316 that is composed of a capacitance sensor. The fully-closing manipulating portion 31c of the touch panel 31 may be a manipulating portion that is manipulated by touch when the user tries to fully close the slide door 20. The fully-closing manipulating portion 31c may have a fully-closing LED 317 and a fully-closing switch 318 that is composed of a capacitance sensor.

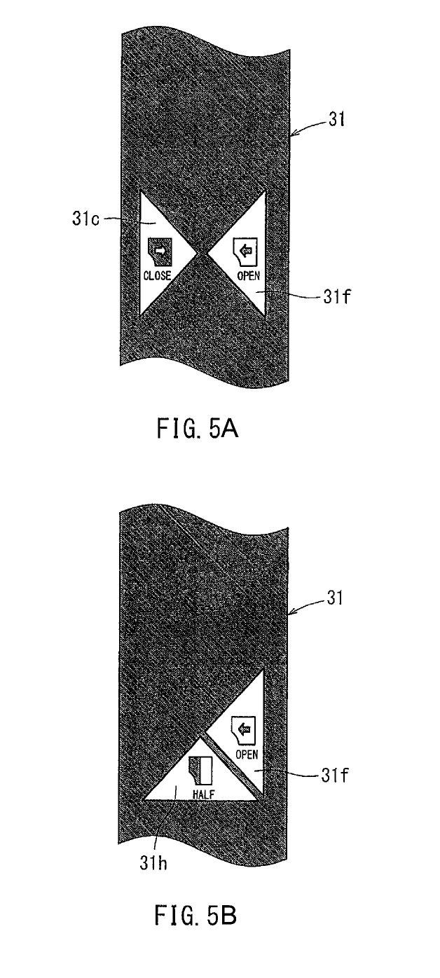

As shown in FIG. 4, the touch panel 31 may have a light guide plate 321 that is capable of conducting, for example, a light emitted from the stopping LED 315 to the stopping manipulating portion 31s, and an insulating film 322 that is laminated on the light guide plate 321. Further, capacitance sensors 323 (the switches) may be laminated on the insulating film 322. Further, a screen 324 on which a graphic of the stopping manipulating portion 31s is printed, may be laminated on the capacitance sensor 323. The screen 324 may be covered by a translucent film 325. According to the structure described above, when the stopping LED 315 is turned on, the light emitted therefrom may be conducted to the stopping manipulating portion 31s via the light guide plate 321, so that the graphic printed on the screen 324 can be illuminated by the light. Further, the stopping LED 315 and the other LEDs may be simply referred to as light sources. Further, because the fully-opening manipulating portion 31f, the half-opening manipulating portion 31h and the fully-closing manipulating portion 31c may be structurally identical with the stopping manipulating portion 31s, a description thereof may be omitted.

As shown in FIG. 2, the touch panel ECU 33 may be a controller that is configured to transmit signals input from the respective manipulating portions 31f, 31h, 31s and 31c of the touch panel 31 to the PSD/ECU 35. Further, the touch panel ECU 33 may be constructed to turn on the LEDs 311, 313, 315 and 317 of the manipulating portions 31f, 31h, 31s and 31c of the touch panel 31, which manipulating portions are capable of being operated in accordance with opening-closing conditions of the slide door 20, in response to signals from the PSD/ECU 35. Further, the touch panel ECU 33 may be constructed to disable functions of the switches 312, 314, 316 and 318 in the manipulating portions 31f, 31h, 31s and 31c of which the LEDs 311, 313, 315 and 317 are not turned on.

<Regarding Operation of Opening-Closing Control Device 30 of Slide Door 20>

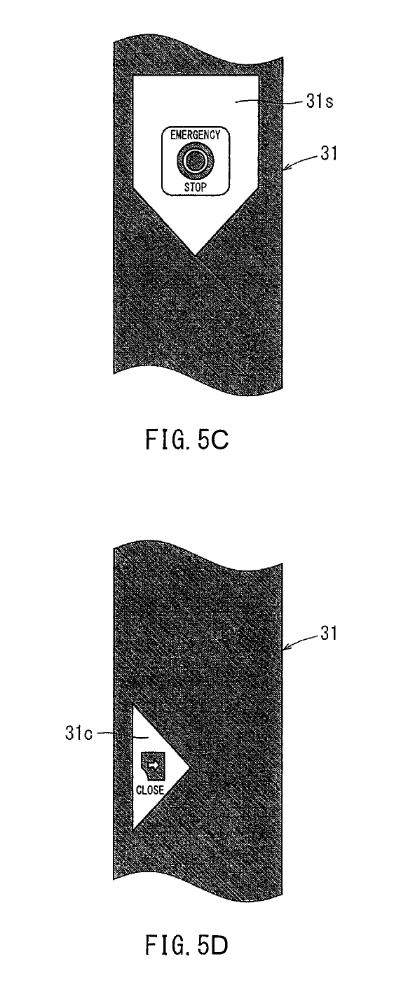

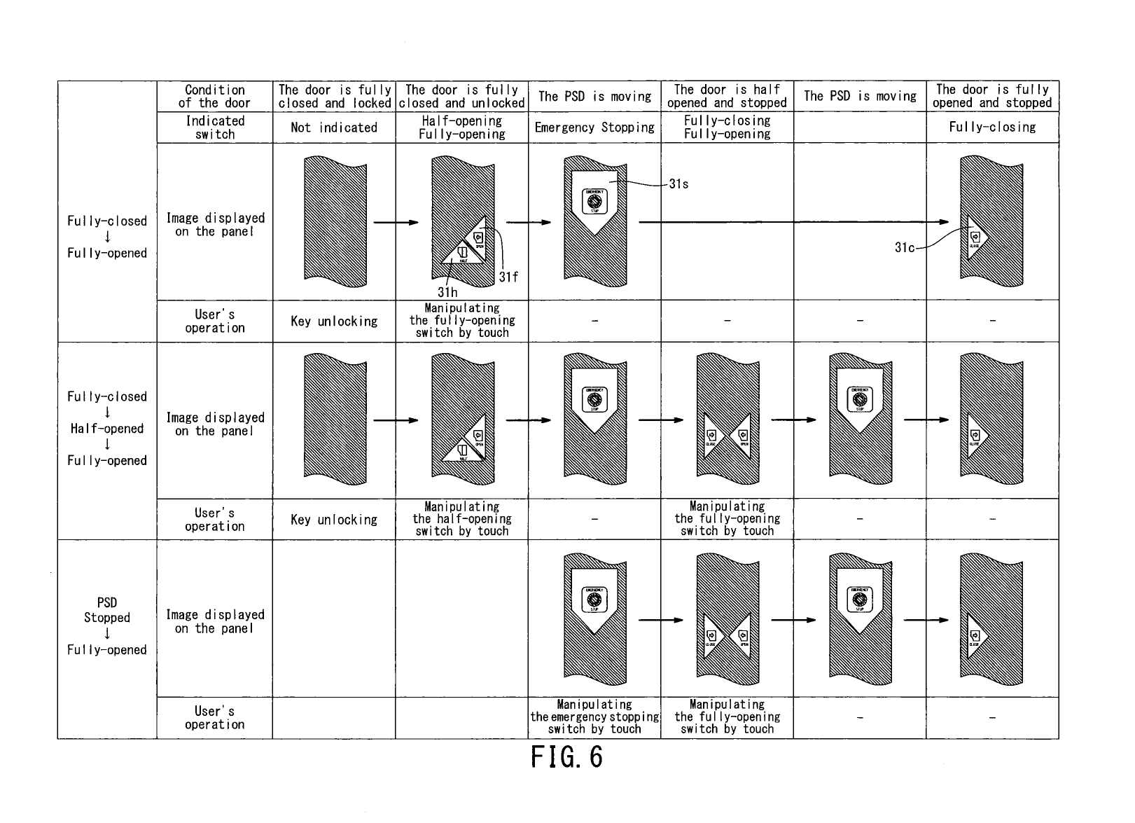

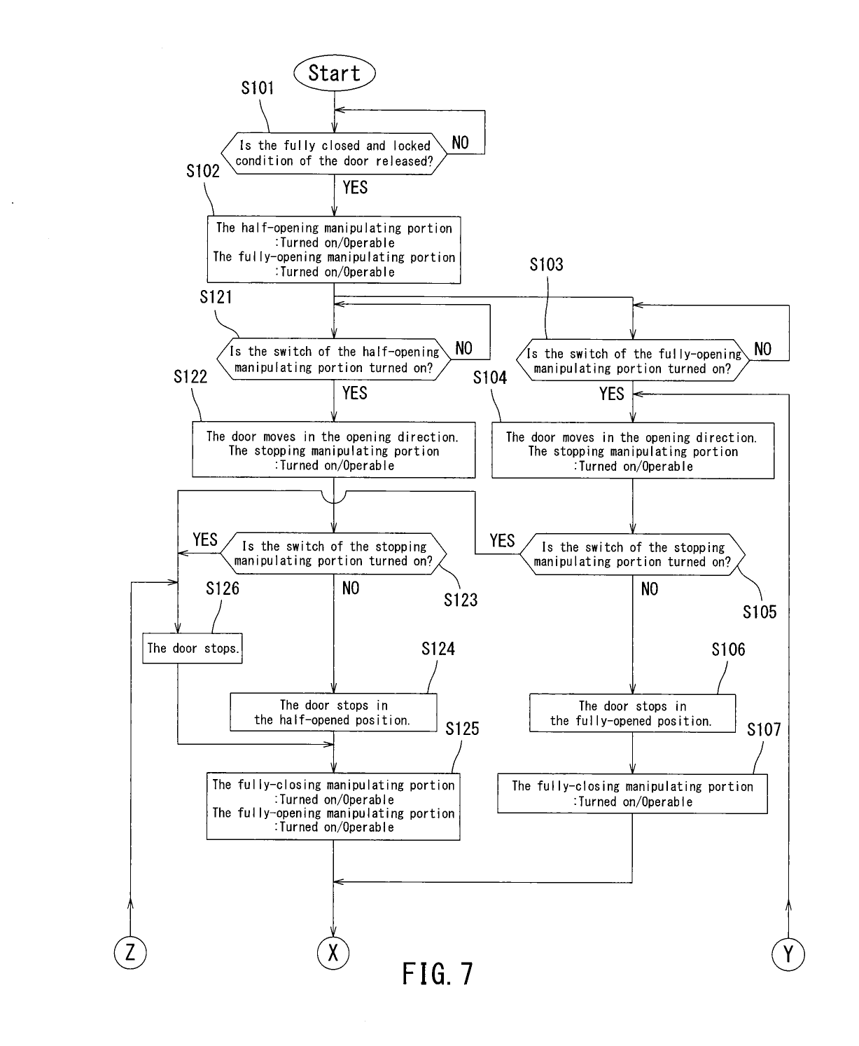

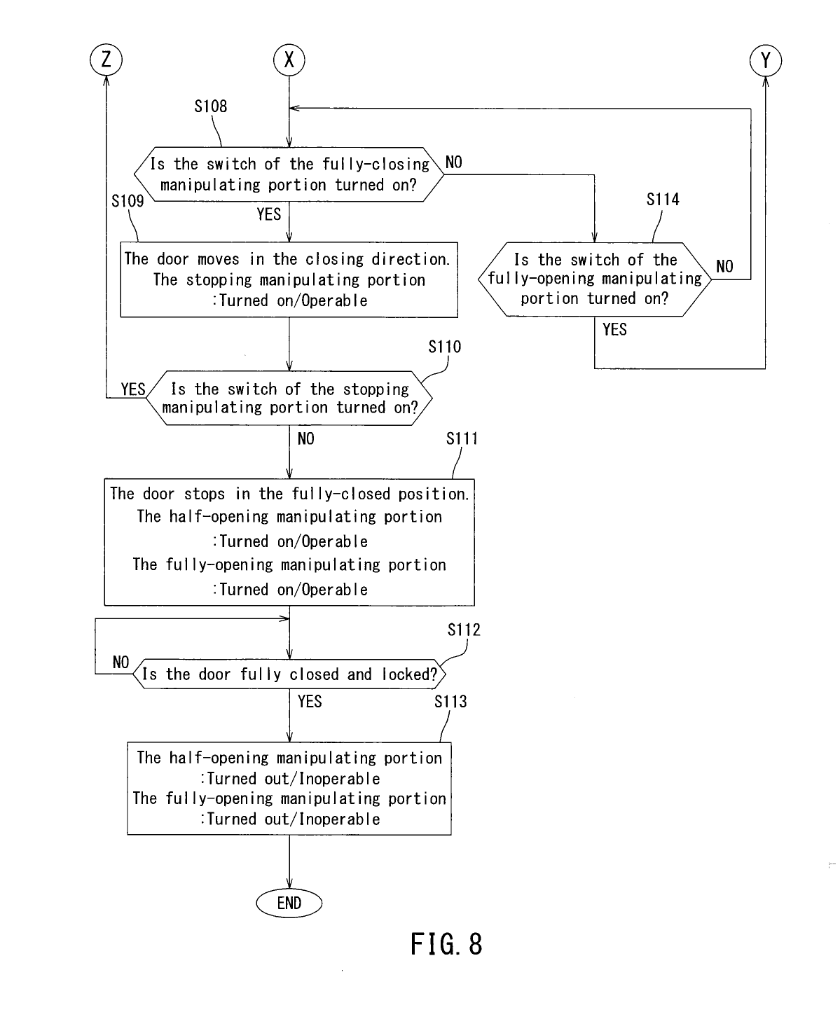

Next, an operation of the opening-closing control device 30 of the slide door 20 will be described with reference to FIGS. 5A to 8. Further, processing of a flow chart shown in FIGS. 7 and 8 may be repeatedly performed at regular time intervals based on a program stored in a memory of the PSD/ECU 35. First, as shown in FIG. 6, when the slide door 20 of the vehicle 10 is in a fully closed and locked condition, the LEDs 311, 313, 315 and 317 in all of the manipulating portions 31f, 31h, 31s and 31c of the touch panel 31 of the slide door 20 may be turned out. In this condition, the functions of the switches 312, 314, 316 and 318 in the respective manipulating portions 31f, 31h, 31s and 31c of the touch panel 31 may be disabled. Next, when the fully closed and locked condition of the slide door 20 is released (YES in Step S101 in FIG. 7), the half-opening LED 313 of the half-opening manipulating portion 31h and the fully-opening LED 311 of the fully-opening manipulating portion 31f of the touch panel 31 may be turned on. As a result, as shown in FIGS. 5B and 6, a graphic of the half-opening manipulating portion 31h and a graphic of the fully-opening manipulating portion 31f can be illuminated. Thus, the half-opening manipulating portion 31h and the fully-opening manipulating portion 31f of the touch panel 31 may respectively become capable of being operated (Step S102 in FIG. 7).

In this condition, when the fully-opening manipulating portion 31f of the touch panel 31 is manipulated by touch, the fully-opening switch 312 of the fully-opening manipulating portion 31f may be turned on (YES in Step S103 in FIG. 7). As a result, the motor 37 of the slide door 20 may be driven, so that the slide door 20 can be slid in the opening direction (Step S104 in FIG. 7). Further, as shown in FIG. 5C and an upper column of FIG. 6, upon sliding of the slide door 20, the fully-opening LED 311 and the half-opening LED 313 may be turned out. Instead, the stopping LED 315 of the stopping manipulating portion 31s can be turned on. As a result, a graphic of the stopping manipulating portion 31s of the touch panel 31 can be illuminated, so that the stopping manipulating portion 31s may become capable of being operated (Step S104 in FIG. 7). Further, as shown in the upper column of FIG. 6, when the slide door 20 reaches a fully-opened position while the stopping manipulating portion 31s of the touch panel 31 is not manipulated by touch (NO in Step S105 in FIG. 7), the motor 37 of the slide door 20 may be stopped, so that the slide door 20 can be held in the fully-opened position (Step S106 in FIG. 7). As a result, the stopping LED 315 of the stopping manipulating portion 31 s of the touch panel 31 can be turned out. Instead, as shown in FIG. 5D and the upper column of FIG. 6, the fully-closing LED 317 of the fully-closing manipulating portion 31c can be turned on. As a result, a graphic of the fully-closing manipulating portion 31c of the touch panel 31 can be illuminated, the fully-closing manipulating portion 31c may become capable of being operated (Step S107 in FIG. 7).

When the fully-closing manipulating portion 31c of the touch panel 31 is manipulated by touch in a condition in which the slide door 20 is held in the fully-opened position, the fully-closing switch 318 of the fully-closing manipulating portion 31c may be turned on (YES in Step S108 in FIG. 8). As a result, the motor 37 of the slide door 20 may be driven, so that the slide door 20 can be slid in the closing direction (Step S109 in FIG. 8). As a result, the fully-closing LED 317 of the fully-closing manipulating portion 31c of the touch panel 31 may be turned out. Instead, the stopping LED 315 of the stopping manipulating portion 31s can be turned on. As a result, as described above, the stopping manipulating portion 31s may become capable of being operated (Step S109 in FIG. 8). Further, when the slide door 20 reaches a fully-closed position while the stopping manipulating portion 31s of the touch panel 31 is not manipulated by touch (NO in Step S110 in FIG. 8), the motor 37 of the slide door 20 may be stopped, so that the slide door 20 can be held in the fully-closed position (Step S111 in FIG. 8). As a result, the stopping LED 315 of the stopping manipulating portion 31s of the touch panel 31 can be turned out. Instead, as shown in FIG. 5B and the upper column of FIG. 6, the fully-opening LED 311 of the fully-opening manipulating portion 31f and the half-opening LED 313 of the half-opening manipulating portion 31h may be turned on. As a result, the fully-opening manipulating portion 31f and the half-opening manipulating portion 31h of the touch panel 31 may respectively become capable of being operated (Step S111 in FIG. 8). Next, when the slide door 20 is fully closed and locked in a condition in which the slide door 20 is held in the fully-closed position (YES in Step S112 in FIG. 8), the fully-opening LED 311 of the fully-opening manipulating portion 31f of the touch panel 31 and the half-opening LED 313 of the half-opening manipulating portion 31h of the touch panel 31 may be turned out. As a result, the fully-opening manipulating portion 31f and the half-opening manipulating portion 31h may respectively become incapable of being operated (Step S113 in FIG. 8).

Further, when the half-opening manipulating portion 31h of the touch panel 31 is manipulated by touch after the fully closed and locked condition of the slide door 20 is released, the half-opening switch 314 of the half-opening manipulating portion 31h may be turned on (YES in Step S121 in FIG. 7). As a result, the motor 37 of the slide door 20 may be driven, so that the slide door 20 can be slid in the opening direction. Further, as shown in FIG. 5C and a center column of FIG. 6, upon sliding of the slide door 20, the fully-opening LED 311 and the half-opening LED 313 may be turned out. Instead, the stopping LED 315 of the stopping manipulating portion 31s can be turned on. As a result, the stopping manipulating portion 31s of the touch panel 31 may become capable of being operated (Step S122 in FIG. 7). Further, as shown in the center column of FIG. 6, when the slide door 20 reaches a half-opened position while the stopping manipulating portion 31s of the touch panel 31 is not manipulated by touch (NO in Step S123 in FIG. 7), the motor 37 of the slide door 20 may be stopped, so that the slide door 20 can be held in the half-opened position (Step S124 in FIG. 7). As a result, the stopping LED 315 of the stopping manipulating portion 31s of the touch panel 31 can be turned out. Instead, as shown in FIG. 5A and the center column of FIG. 6, the fully-closing LED 317 of the fully-closing manipulating portion 31c and the fully-opening LED 311 of the fully-opening manipulating portion 31f may be turned on. Thus, the fully-closing manipulating portion 31c and the fully-opening manipulating portion 31f of the touch panel 31 may respectively become capable of being operated (Step S125 in FIG. 7).

When the fully-closing manipulating portion 31c of the touch panel 31 is manipulated by touch in a condition in which the slide door 20 is held in the half-opened position, the fully-closing switch 318 of the fully-closing manipulating portion 31c may be turned on (YES in Step S108 in FIG. 8). As a result, the slide door 20 can be slid to the fully-closed position via processing in Step S109 to Step S111 (FIG. 8) described above. Further, when the fully-opening manipulating portion 31f of the touch panel 31 is manipulated by touch in the condition in which the slide door 20 is held in the half-opened position (NO in Step S108, YES in Step S114 in FIG. 8), the slide door 20 can be slid to the fully-opened position (the central column of FIG. 6) via processing in Step S104 to Step S107 (FIG. 7) described above. Further, when the stopping manipulating portion 31s of the touch panel 31 is manipulated by touch while the slide door 20 is sliding (YES in Step S105 in FIG. 7, YES in Step S123 in FIG. 7, YES in Step S110 in FIG. 8), the slide door 20 can be stopped at the position (Step S126 in FIG. 7). Further, the stopping LED 315 of the stopping manipulating portion 31s of the touch panel 31 can be turned out. Instead, as shown in FIG. 5A and a lower column of FIG. 6, the fully-closing LED 317 of the fully-closing manipulating portion 31c and the fully-opening LED 311 of the fully-opening manipulating portion 31f may be turned on. Thus, the fully-closing manipulating portion 31c and the fully-opening manipulating portion 31f of the touch panel 31 may respectively become capable of being operated (Step S125 in FIG. 7). Further, movements of the slide door 20 after the fully-closing manipulating portion 31c or the fully-opening manipulating portion 31f of the touch panel 31 is manipulated by touch may be the same as described above.

<Advantages of Opening-Closing Control Device 30 of Slide Door 20 of Present Embodiment>

According to the opening-closing control device 30 of the slide door 20 of the present embodiment, the LEDs 311, 313, 315 and 317 (the light sources) corresponding to the manipulating portions 31f, 31h, 31s and 31c that are operable in accordance with the opening-closing conditions of the slide door 20 can be turned on, so that the graphics (images) of the operable manipulating portions 31f, 31h, 31s and 31c can be illuminated. For example, when the slide door 20 is fully closed, the LEDs 311 and 313 corresponding to the manipulating portions for moving the slide door 20 in the opening direction (the fully-opening manipulating portion 31f and the half-opening manipulating portion 31h) can be turned on, so that the graphics (the images) of the fully-opening manipulating portion 31f and the half-opening manipulating portion 31h can be illuminated. To the contrary, when the slide door 20 is fully opened, the LED 317 corresponding to the manipulating portion for moving the slide door 20 in the closing direction (the fully-closing manipulating portion 31c) can be turned on, so that the graphic of the fully-closing manipulating portion 31c can be illuminated. Therefore, even if the user is inexperienced in use of the touch panel 31, the user can easily utilize the touch panel 31. In addition, because the manipulating portions corresponding to the LEDs (the light sources) that are turned out are inoperable, even if the manipulating portions corresponding to the LEDs (the light sources) that are turned out are inadvertently manipulated by the user, the slide door 20 can be prevented from moving against user's will. Further, the touch panel 31 may be attached to the front frame 27f constituting the window frame of the slide door 20. That is, the touch panel 31 can be positioned adjacent to the grip handle 25h of the slide door 20. Therefore, the user can easily touch the touch panel 31 during the opening-closing operation of the slide door 20.

<Modified Form>

An embodiment of the present invention has been described as above. However, it would have been easy for those skilled in the art that various changes, improvements and modifications may be made to the embodiment without departing from the object of the invention. Therefore, the embodiment of the present invention may contain all of the changes, improvements and modifications that do not depart from the sprit and the object of the attached claims. For example, the embodiment of the present invention may not be limited to the special structure described above and may be changed as follows.

For example, in the present embodiment, the touch panel 31 may be attached to the front frame 27f constituting the window frame of the slide door 20. However, the touch panel 31 can be positioned along the grip handle 25h of the slide door 20 at the substantially same level as the grip handle 25h. Further, the touch panel 31 and the grip handle 25h can be integrated with each other. In addition, the touch panel 31 can be attached to the body side surface adjacent to the slide door 20.

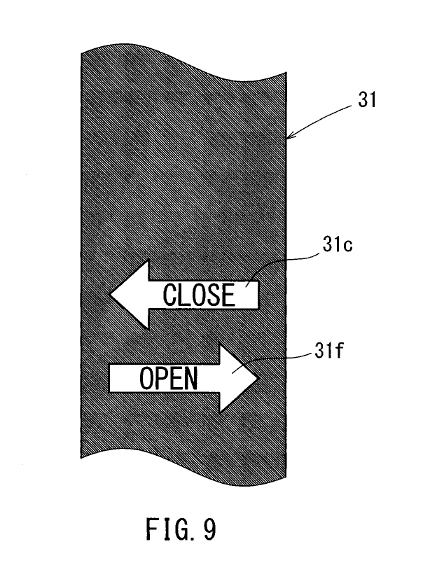

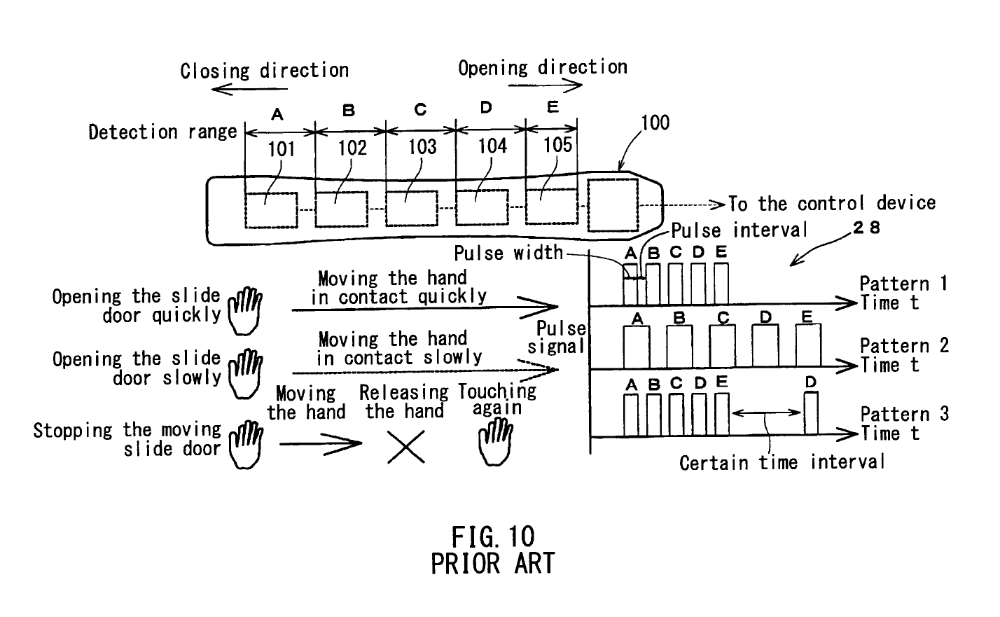

Further, as shown in FIG. 3 or other figures, in the present embodiment, the fully-closing manipulating portion 31c and the fully-opening manipulating portion 31f of the touch panel 31 may be positioned opposite to each other. However, as shown in FIG. 9, the fully-closing manipulating portion 31c and the fully-opening manipulating portion 31f can respectively be designed as large graphic arrows showing door moving directions and be juxtaposed to each other . Further, a layout of the manipulating portions 31f, 31h, 31s and 31c of the touch panel 31 can be appropriately changed as necessary.

Further, in the present embodiment, when the slide door 20 of the vehicle 10 is in the fully closed and locked condition, the functions of the switches 312, 314, 316 and 318 in all of the manipulating portions 31f, 31h, 31s and 31c of the touch panel 31 may be disabled. However, it is possible to modify such that even if the slide door 20 is in the fully closed and locked condition, the half-opening manipulating portion 31h and the fully-opening manipulating portion 31f of the touch panel 31 can be operated provided that, for example, the PSD/ECU 35 or other such ECUs detects that the user is approaching the door with an authentication key.

1. An opening-closing control device of a slide door that is configured to slide along a body side surface of a vehicle in a vehicle front-back direction using a motor as a drive source in order to open and close an entrance of the vehicle, comprising:
a touch panel for performing an opening-closing operation of the slide door, the touch panel being attached to an outer surface of a member constituting an outer shell of the vehicle,
wherein the touch panel has a plurality of manipulating portions, and light sources corresponding to the manipulating portions, and
wherein the light sources corresponding to the manipulating portions that are operable in accordance with opening-closing conditions of the slide door are configured to be turned on, so that images of the operable manipulating portions manipulated are illuminated.

2. The opening-closing control device of the slide door according to claim 1, wherein the manipulating portions corresponding to the light sources that are turned out are inoperable.

3. The opening-closing control device of the slide door according to claim 1, wherein the touch panel is attached to a front frame constituting a window frame of the slide door.

4. The opening-closing control device of the slide door according to claim 1, wherein when the slide door is held in a fully-closed position, the light sources corresponding to a fully-opening manipulating portion and a half-opening manipulating portion are turned on, so that images of the fully-opening manipulating portion and the half-opening manipulating portion are illuminated.

5. The opening-closing control device of the slide door according to claim 1, wherein when the slide door is held in a fully-opened position, the light source corresponding to a fully-closing manipulating portion is turned on, so that an image of the fully-closing manipulating portion is illuminated.

6. The opening-closing control device of the slide door according to claim 1, wherein when the slide door is sliding, the light source of a stopping manipulating portion of the slide door is turned on, so that an image of the stopping manipulating portion is illuminated.

7. The opening-closing control device of the slide door according to claim 1, wherein when the slide door is held in a fully-closed position and is in a fully closed and locked condition, the light sources corresponding to all of the manipulating portions are turned out, so that the manipulating portions are inoperable.
